(19) United States
(12) Patent Application Publication
(10) Pub. No.: US 2026/0366924 A1
(43) Pub. Date: Nov. 19, 2026

(54) Intelligent Adaptive Wavefront Measurement System and Method for Optical Characterization

(71) Applicant: The Hong Kong Polytechnic University, Hong Kong (CN)

(72) Inventors: Chi Fai Benny CHEUNG, Hong Kong (CN); Bo WANG, Hong Kong (CN); Sanshan GAO, Hong Kong (CN); Lai Ting Lesley HO, Hong Kong (CN)

(21) Appl. No.: 19/133,809

(22) PCT Filed: May 16, 2023
(86) PCT No.: PCT/CN2023/094445

§ 371 Date: May 29, 2025

(51) Int. Cl. G01J 9/02; G01J 9/00

(52) U.S. Cl. CPC G01J 9/0215; G01J 2009/002; G01J 2009/0249

(57) ABSTRACT

The present invention provides an intelligent adaptive wavefront measurement system for optical characterization. The system can obtain optical parameters of a sample to be measured. The system comprises a light source, a shearing generator, and a photoelectric coupling device which are sequentially arranged in the axial direction, wherein the shearing generator comprises a spatial light modulator and a phase difference micro-lens array which are sequentially arranged in the axial direction. In addition, the present invention further provides a corresponding method and a training method in a simulation environment, such that a machine learning-based adaptive technology is used for wavefront modulation of the spatial light modulator.

### TECHNICAL FIELD

The present invention relates to an intelligent adaptive measurement system for optical characterization and a method thereof.

### BACKGROUND

The continuous progress of new optical design methods, new materials and new systems has greatly promoted the innovation, research and development of new products, but has put forward higher requirements for their optical characterization as well at the same time. Optical characterization refers to utilizing optical parameters to determine the acceptability of an optical system or optical device under specific performance requirements. It is needed extensively in different fields, such as the degree distribution of spectacle lens in opticianry, the quality of the laser beam in two-photon 3D printing, the refractive index distribution in material science, the assembly errors of high numerical aperture objective lens, and the focal length, optical transfer function (OTF) and modulation transfer function (MTF) of super lens, etc. Optical characterization is a multi-parameter and complex measurement process. Although there are some devices and instruments available to measure individual optical parameters in specific fields, methods and devices that can accurately measure multiple optical parameters comprehensively in a single system are still unavailable at present.

Wavefront measurement is an effective approach to perform optical characterization, and is mainly defined by calculating the deviation between the actual wavefront and the ideal wavefront. Wavefront measurement detects the phase change of the measured light beam after passing through different media or components, and utilizes the principle of interference to perform non-destructive detection of an object to be measured. FIG. 1 shows a schematic structural diagram of an optical system 100 using a wavefront measurement method in the prior art. Traditional wavefront measurement methods mainly include a point diffraction method, a Shack-Hartmann method and a four-wave lateral shearing method.

The traditional interference detection relies on a standard lens in the optical path to generate a reference wavefront. As a result, the traditional interference detection not only poses limitations on the detection aperture of the interference system, but also has difficulties in generating a high-quality spherical reference wavefront and is unable to perform high-precision optical detection owing to the limited machining accuracy of the standard reference lens. The point diffraction method uses a small hole in size close to the detection wavelength to generate an almost ideal spherical wave as a reference wavefront in the interference detection system, thereby realizes high-precision interference detection. Specifically, with the point diffraction method, the converged wavefront to be measured is diffracted through a small hole in the point diffraction plate to generate an approximately ideal spherical reference wave, while the wave directly transmitted from the point diffraction plate is the test light wave carrying the information on the wavefront to be measured; the two waves interfere with each other, and the phase distribution of the wavefront to be measured can be demodulated from an interferogram. The point diffraction method has a strong ability to resist environmental interferences because it doesn't need a reference lens. However, the point diffraction method has extremely high requirements for the machining accuracy of the small hole in the diffraction plate, it is difficult to achieve light beam alignment, and the contrast of the interferogram is low because of a blocking effect of the small hole on the measuring beam.

The Hartmann method uses an array of holes arranged according to a certain rule as a diaphragm, as shown in FIG. 2A, and controls the transmission of light rays at different positions by means of the array of holes, so that the light rays finally reach a receiving screen at different gradients. However, such a diaphragm blocks most of the energy, consequently it is difficult to measure the final optical spot. The Shack-Hartmann method makes an improvement by replacing the Hartmann diaphragm with a micro-lens array, as shown in FIG. 2B. Although the Shack-Hartmann method greatly improves the utilization of the optical energy, it is limited by the manufacturing technology of micro-lenses (the size and quantity of the micro-lenses are limited), consequently the sampling points of the wavefront to be measured are limited, and the spatial resolution of the method is not high.

The four-wave lateral shearing method utilizes a checkerboard grating (as shown in FIG. 2C) as a beam splitting element. After the light wave passes through the grating, a replica light wave having certain lateral shift from the original light wave is obtained, and the replica light wave interferes with the light wave to be measured, forming lateral shearing interference, with interference fringes appearing at the overlapped region of the two light waves. The interference fringes contain the differential information of the original wavefront, and the original wavefront can be reproduced through specific analysis and quantitative calculations (inverse Fourier transform). The four-wave lateral shearing method greatly simplifies the system structure, but still has some problems, for example, the influence of higher-order diffractions still exists, and high-precision measurement can be realized only at positions at multiples of ⅙ Talbot distance.

### SUMMARY

In order to overcome the above problems, the present invention provides an adaptive intelligent wavefront measurement method and a system utilizing the method. A spherical wave or planar wave emitted from a light source is distorted after it passes through a system or device to be measured; the distorted wavefront is replicated by a specially designed shearing generator into a plurality of wavefronts to be measured, and the wavefronts interfere with each other; an interferogram formed by the wavefronts is recoded by a charge-coupled device (CCD), the information of the wavefront to be measured can be obtained by reconstructing the interferogram, and the optical parameters to be measured can be obtained by means of a mapping method. The shearing generator is composed of a spatial light modulator (SLM) and a micro-lens array with optical phase differences (OPD-MLA). With an adaptive technique based on machine learning, the spatial light modulator is automatically modulated to meet the requirements in different measurement scenarios. The present invention expands the application range of wavefront measurement, improves the accuracy of wavefront measurement, and makes rapid and convenient optical characterization possible.

The present invention provides a novel intelligent adaptive measurement system for optical characterization. It can be widely used in optical parameter measurement, such as light beam quality evaluation, optical element detection, meta-surfaces, refractive indexes of materials, laser atmospheric communication, and human eye aberration measurement, etc. Compared with traditional interferometers, the system doesn't require reference light; instead, it utilizes a shearing generator to replicate the wavefront to be measured, and then the wavefronts interfere with each other. An interferogram recorded by a CCD contains wavefront information in all shearing directions, and the phase information of the sample to be measured can be obtained by using wavefront reconstruction technology. The system has a simple structure and a strong anti-environmental interference ability, and is suitable for on-line measurement. An adaptive technique is applied to the wavefront modulation of the shearing generator, and the shearing generator has the ability to automatically adjust key shearing parameters (e.g., duty ratio, shearing amount and illumination intensity, etc.) to meet the requirements in different application scenarios; the obtained interferogram has low noise and high and stable contrast. The present invention expands the application range of wavefront measurement and improves the accuracy of wavefront measurement.

Specifically, the present invention provides an intelligent adaptive wavefront measurement system for optical characterization, which is capable of obtaining the optical parameters of a sample to be measured, and comprises a light source, a shearing generator and a photoelectric coupler that are arranged sequentially in an axial direction, wherein the shearing generator comprises a spatial light modulator and a phase-difference micro-lens array that are arranged sequentially in the axial direction.

In some embodiments, the phase-difference micro-lens array comprises front convex micro-lenses and rear convex micro-lenses that are arranged in a staggered manner on adjacent grids, and the phase-difference micro-lens array performs π phase modulation on incident light waves by means of the height difference between a top part of the front convex micro-lenses and a top part of the rear convex micro-lenses in the axial direction.

In some embodiments, in subsequent wavefront reconstruction operations, the light transmittance of the top part of the front convex micro-lenses is calculated as 1, the light transmittance of the top part of the substrate of the phase-difference micro-lens array is calculated as 0, and the light transmittance of the top part of the rear convex micro-lenses is calculated as −1, wherein the height difference is

$$h = \frac{λ}{2 ( n - 1 )} ,$$

where n is the refractive index of the material of the phase-difference micro-lens array, and λ is the incident wavelength.

In some embodiments, a duty ratio of each micro-lens in the phase-difference micro-lens array in the grid of the micro-lens is

$$\frac{π {r}^{2}}{{d}^{2}} ,$$

where r is the radius of the aperture of each micro-lens and d is the spacing between the grids.

In some embodiments, the duty ratio is 2:3.

In some embodiments, a shearing ratio of the shearing generator is

$$β = \frac{S}{D} ,$$

where S is the shearing amount, and D is the aperture of the incident light, wherein

$$S = 2 L tan [ arcsin ( \frac{n λ}{d} ) ] + 2 H tan [ arcsin ( \frac{λ}{d} ) ] ,$$

where L is the distance between the photoelectric coupler and the phase-difference micro-lens array, H is the thickness of the substrate of the phase-difference micro-lens array, λ is the incident wavelength, and d is the spacing between the grids.

In some embodiments, the spatial light modulator modulates shearing parameters, which include at least one of the duty ratio, the shearing amount and the illumination intensity of each micro-lens in the phase-difference micro-lens array in the grid of the micro-lens.

In some embodiments, the spatial light modulator optimizes its modulation mode based on a machine learning model, so that the machine learning model can output an adaptive modulation mode for the sample to be measured according to a spectral signal in an initial modulation mode.

In some embodiments, the machine learning model is established by using a deep convolution neural network.

In some embodiments, the machine learning model is capable of optimizing the modulation mode of the spatial light modulator such that only the signal order 0 and orders ±1 in the spectral signal corresponding to the light intensity distribution of the wavefront received on the photoelectric coupler are left.

In some embodiments, a training process of the machine learning model can be carried out in a simulation environment; the optical parameters of the designed structure are obtained in the simulation by designing a sample to be measured with a complex structure; in view that the optical parameters are known, the optical parameters are used as true values for training the deep convolutional neural network, and finally a trained machine learning model is obtained through continuous iterative learning and training.

In addition, the present invention further discloses an intelligent adaptive wavefront measurement method for optical characterization, which comprises the following steps: a) introducing an incident light wave from a light source to pass through a sample to be measured, a shearing generator and a photoelectric coupler that are sequentially arranged in an axial direction, to obtain the light intensity distribution of a wavefront, wherein the shearing generator comprises a spatial light modulator and a phase-difference micro-lens array that are arranged sequentially in the axial direction; b) transforming the light intensity distribution of the wavefront through a Fourier transform, to obtain a spectral signal corresponding to the light intensity distribution of the wavefront; and c) transforming the spectral signal through an inverse Fourier transform and performing shearing interference signal processing, to obtain the optical parameters of the sample to be measured.

In some embodiments, the phase-difference micro-lens array comprises front convex micro-lenses and rear convex micro-lenses that are arranged in a staggered manner on adjacent grids, and the phase-difference micro-lens array performs π phase modulation on incident light waves by means of the height difference between the top part of the front convex micro-lenses and the top part of the rear convex micro-lenses in the axial direction.

In some embodiments, the light transmittance of the front convex micro-lenses is 1, the light transmittance of the bottom part is 0, and the light transmittance of the rear convex micro-lenses is −1, wherein the height difference is

$$h = \frac{λ}{2 ( n - 1 )} ,$$

where n is the refractive index of the material of the phase-difference micro-lens array, and A is the incident wavelength.

In some embodiments, a duty ratio of each micro-lens in the phase-difference micro-lens array in the grid of the micro-lens is

$$\frac{π {r}^{2}}{{d}^{2}} ,$$

where r is the radius of the aperture of each micro-lens and d is the spacing between the grids.

In some embodiments, the duty ratio is 2:3.

In some embodiments, a shearing ratio of the shearing generator is

$$β = \frac{S}{D} ,$$

where S is the shearing amount, and D is the aperture of the incident light, wherein

$$S = 2 L tan [ arcsin ( \frac{n λ}{d} ) ] + 2 H tan [ arcsin ( \frac{λ}{d} ) ] ,$$

where L is the distance between the photoelectric coupler and the phase-difference micro-lens array, H is the thickness of the substrate of the phase-difference micro-lens array, λ is the incident wavelength, and d is the spacing between the grids.

In some embodiments, the spatial light modulator modulates shearing parameters, which include at least one of the duty ratio, the shearing amount and the illumination intensity of each micro-lens in the phase-difference micro-lens array in the grid of the micro-lens.

In some embodiments, the spatial light modulator optimizes its modulation mode based on a machine learning model, so that the machine learning model can output an adaptive modulation mode for the sample to be measured according to a spectral signal in an initial modulation mode.

In some embodiments, the machine learning model is established by using a deep convolution neural network.

In some embodiments, the machine learning model is capable of optimizing the modulation mode of the spatial light modulator such that only the signal order 0 and orders ±1 in the spectral signal corresponding to the light intensity distribution of the wavefront received on the photoelectric coupler are left.

In some embodiments, a training process of the machine learning model can be carried out in a simulation environment; the optical parameters of the designed structure are obtained in the simulation by designing a sample to be measured with a complex structure; in view that the optical parameters are known, the optical parameters are used as true values for training the deep convolutional neural network, and finally a trained machine learning model is obtained through continuous iterative learning and training.

Besides, the present invention further discloses a training method for an intelligent adaptive wavefront measurement method for optical characterization in a simulation environment, which comprises the following steps: a) in a simulation environment, introducing an incident light wave from a light source to pass through a sample with known optical parameters, a spatial light modulator, a phase-difference micro-lens array and a photoelectric coupler that are arranged sequentially in an axial direction, to obtain initial light intensity distribution of a wavefront, wherein the spatial light modulator works in an initial modulation mode; b) transforming the initial light intensity distribution of the wavefront through a Fourier transform, to obtain an initial spectral signal corresponding to the initial light intensity distribution of the wavefront; c) inputting the initial spectral signal and the current modulation mode into a machine learning model established by using a deep convolution neural network, performing feature extraction and reconstruction on the inputted signal through deep convolution, and outputting an adjusted modulation mode; d) calculating the remaining orders in the spectral signal at this point, and taking account of the training loss for model training; e) obtaining adjusted light intensity distribution of the wavefront based on the adjusted modulation mode, and transforming the adjusted light intensity distribution of the wavefront through a Fourier transform to obtain an adjusted spectral signal corresponding to the adjusted light intensity distribution of the wavefront; f) transforming the adjusted spectral signal through an inverse Fourier transform and performing shearing interference signal processing to obtain the optical parameters of the sample, and calculating the errors between the obtained optical parameters and true values of the known optical parameters, and taking account of the errors into the training loss; and g) iteratively training the model according to the obtained training loss, and finally obtaining a trained machine learning model.

In addition, the present invention further discloses an intelligent adaptive wavefront measurement method for optical characterization, which comprises the following steps: a) introducing an incident light wave from a light source to pass through a sample to be measured, a spatial light modulator, a phase-difference micro-lens array and a photoelectric coupler that are arranged sequentially in an axial direction, to obtain initial light intensity distribution of a wavefront, wherein the spatial light modulator works in an initial modulation mode; b) transforming the initial light intensity distribution of the wavefront through a Fourier transform, to obtain an initial spectral signal corresponding to the initial light intensity distribution of the wavefront; c) inputting the initial spectral signal and the current modulation mode into a trained machine learning model, performing feature extraction and reconstruction on the inputted signal through deep convolution, and adjusting the modulation mode such that only the signal order 0 and orders ±1 in the spectral signal corresponding to the light intensity distribution of the wavefront received on the photoelectric coupler are left; d) adjusting the modulation mode of the spatial light modulator based on the adjusted modulation mode to obtain optimized light intensity distribution of the wavefront, and transforming the optimized light intensity distribution of the wavefront through a Fourier transform to obtain an optimized spectral signal corresponding to the optimized light intensity distribution of the wavefront; and e) transforming the optimized spectral signal through an inverse Fourier transform and performing shearing interference signal processing, to obtain the optical parameters of the sample to be measured.

Other features and advantages of the present invention will become apparent from the following detailed description, accompanying drawings and claims.

### BRIEF DESCRIPTION OF THE DRAWINGS

The forementioned and additional features of the present invention will become apparent from the following description of exemplary preferred embodiments in conjunction with the accompanying drawings, in which:

FIG. 1 shows a schematic structural diagram of an optical system utilizing a wavefront measurement method in the prior art;

FIG. 2A shows a schematic diagram of a Hartmann diaphragm in the prior art;

FIG. 2B shows a schematic diagram of a micro-lens array in the Shack-Hartmann method in the prior art;

FIG. 2C shows a schematic diagram of a checkerboard grating in the four-wave lateral shearing method in the prior art;

FIG. 3 shows a schematic diagram of an intelligent adaptive wavefront measurement system for optical characterization according to an embodiment of the present invention;

FIG. 4 shows a schematic diagram of a shearing interference wavefront received on a CCD camera according to an embodiment of the present invention;

FIG. 5 shows a schematic diagram of a wavefront reconstruction algorithm according to an embodiment of the present invention;

FIG. 6 shows a schematic diagram of the phase distribution of the wavefront to be measured according to an embodiment of the present invention;

FIGS. 7A-7C show schematic diagrams of a phase-difference micro-lens array according to an embodiment of the present invention;

FIG. 7D shows a schematic diagram of the incident light aperture and shearing amount according to an embodiment of the present invention;

FIG. 7E shows a schematic diagram of the distance between the CCD camera and the phase-difference micro-lens array according to an embodiment of the present invention;

FIG. 8 shows a schematic diagram of the wavefront modulation based on machine learning according to an embodiment of the present invention;

FIG. 9 shows a method for self-optimization of the shearing interference modulation mode based on machine learning according to an embodiment of the present invention;

FIG. 10 shows a flowchart of a training method for the intelligent adaptive wavefront measurement method for optical characterization in a simulation environment according to some embodiments of the present invention;

FIG. 11 shows a flowchart of the intelligent adaptive wavefront measurement method for optical characterization according to some embodiments of the present invention;

FIG. 12A shows an unmodulated spectrogram according to an embodiment of the present invention; and

FIG. 12B shows a modulated spectrogram according to an embodiment of the present invention.

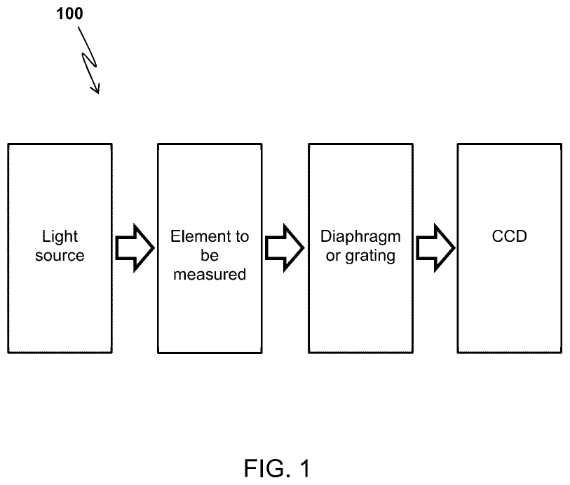

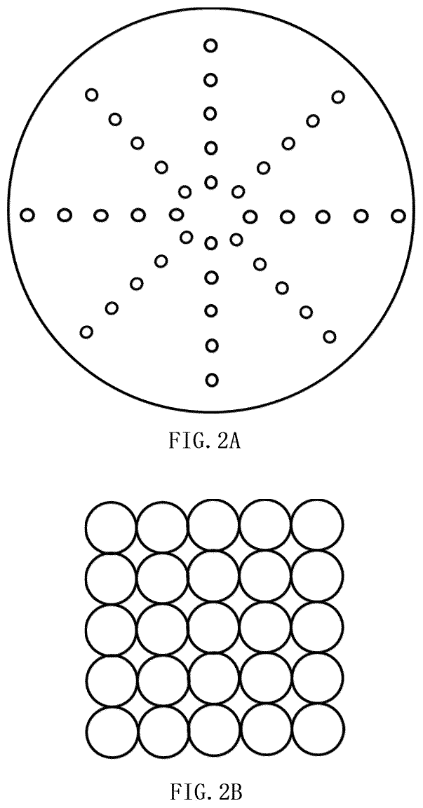

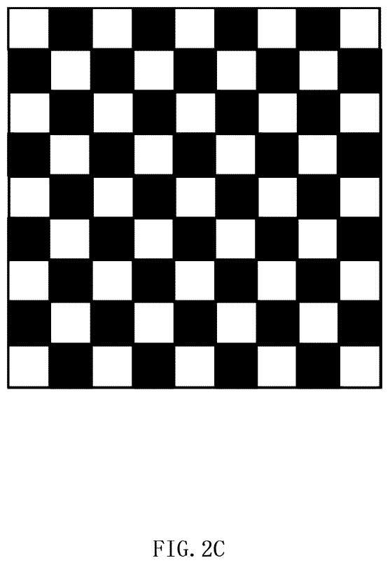

### DETAILED DESCRIPTION

In the following claims and the above description of the present invention, the term “comprise” or its variants (e.g., “include” or “contain”) are used in an inclusive manner, i.e. it indicates the presence of the stated features, but doesn't exclude the presence or addition of additional features in various embodiments of the present invention, unless the context specifies otherwise owing to the expressive language or necessary implication. Besides, unless otherwise specified, the dimensions and scales in the drawings do not represent the actual dimensions and scales of the components.

It should be understood that the reference to any prior art publication herein doesn't constitute an admission that the publication is part of the common knowledge in any country and in the art.

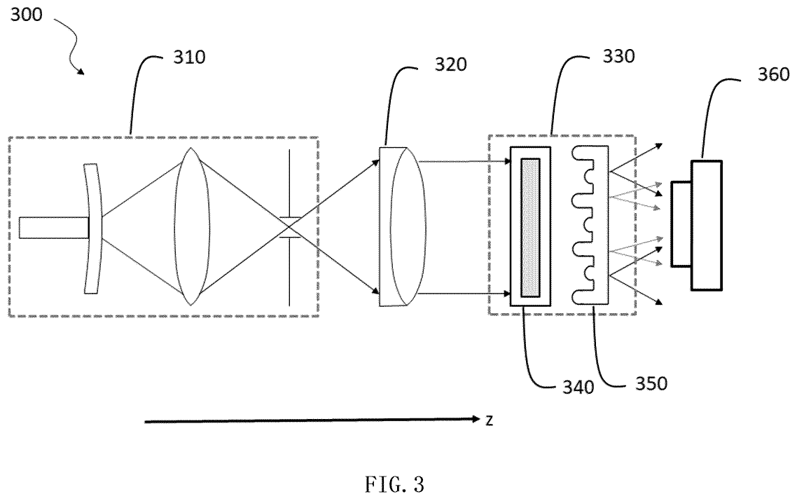

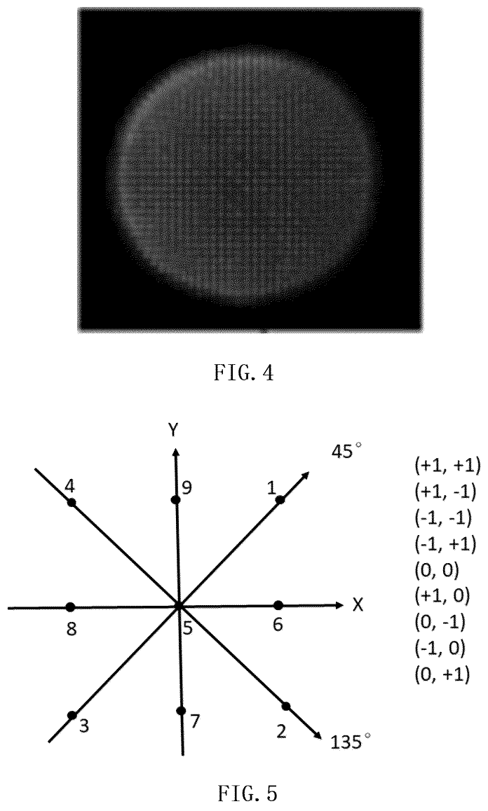

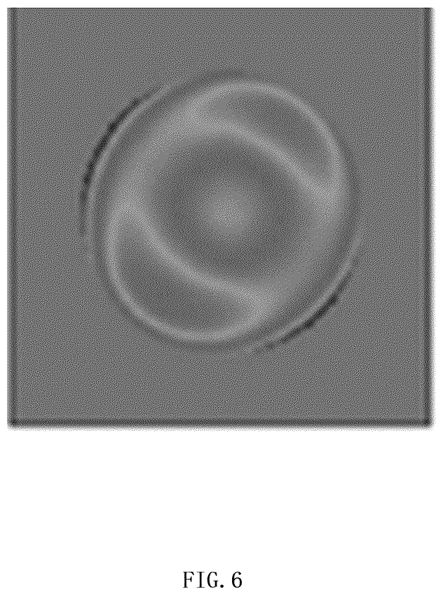

FIG. 3 shows a schematic diagram of an intelligent adaptive wavefront measurement system 300 for optical characterization according to an embodiment of the present invention. The system 300 comprises a light source 310, a sample 320 to be measured, a shearing generator 330, and a CCD camera 360. The above components may be arranged sequentially in an axial direction z. The light source 310 is configured to generate, for example, a standard planar wave or spherical wave. The light source may be a laser diode light source, and its wavelength range may be, for example, 380 nm-1,200 nm, preferably in the visible light band. The shearing generator 330 is composed of a spatial light modulator 340 and a phase-difference micro-lens array 350, which will be described in detail later. As a beam splitting element, the shearing generator 300 replicates the wavefront to be measured into a plurality of wavefronts at the same time, and the replica wavefronts are staggered from each other on an observation surface of the CCD camera 360 owing to their different spatial emergence angles, forming a shearing interference wavefront in multiple directions, as shown in FIG. 4, which shows a schematic diagram of the shearing interference wavefront received on the CCD camera according to the embodiment of the present invention. The CCD camera 360 is only exemplary, and may be any other device that converts or couples optical signals into electrical signals. The system 300 utilizes a single interferogram that contains lateral shearing interference information in multiple directions, and utilizes a wavefront reconstruction algorithm as shown in FIG. 5, which shows a schematic diagram of the wavefront reconstruction algorithm according to an embodiment of the present invention. Thus, the system realizes the measurement of the phase distribution of the wavefront to be measured, as shown in FIG. 6, which shows a schematic diagram of the phase distribution of the wavefront to be measured according to an embodiment of the present invention.

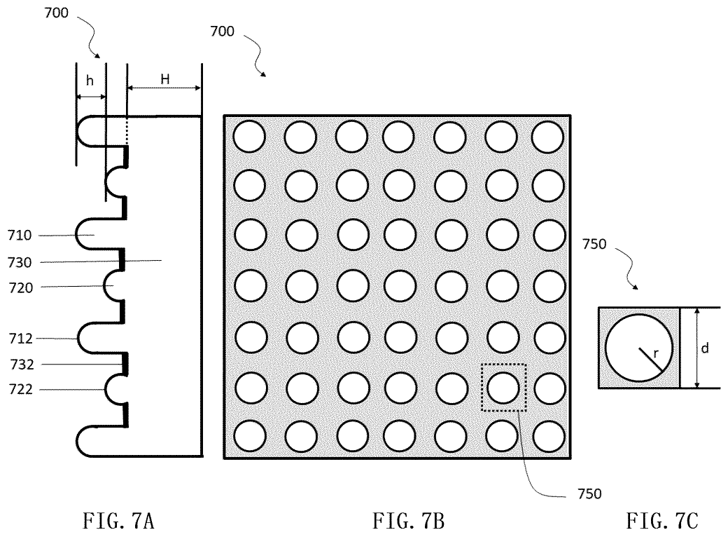

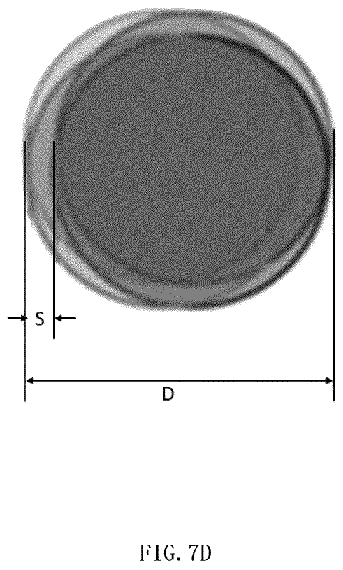

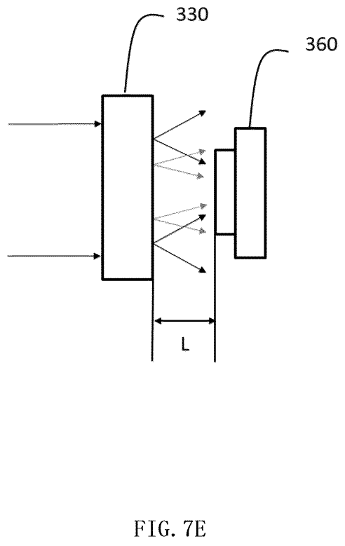

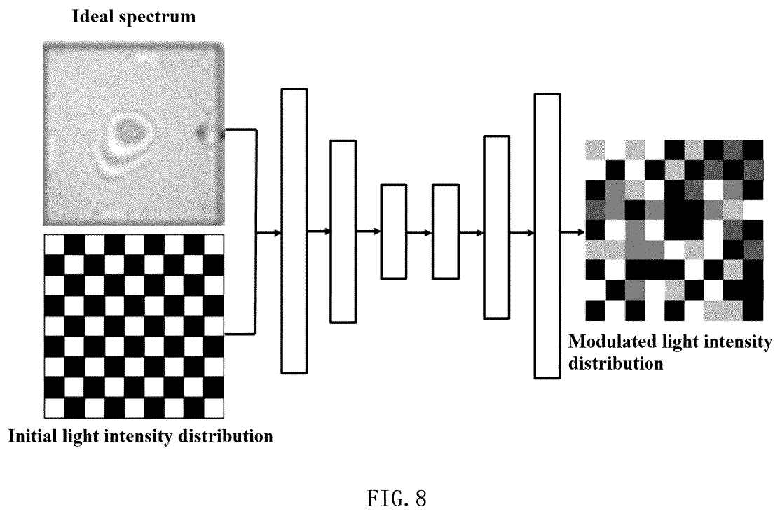

The most crucial optical element in the wavefront measurement system is the grating that serves as a beam splitting element. After the light wave to be measured passes through the grating, multiple diffraction orders will be generated owing to a diffraction effect of the grating. By designing a special grating structure, the other diffraction orders in the Fraunhofer diffraction field should be eliminated as much as possible, except for four diffraction orders (orders ±1) that participate in the interference in two orthogonal directions, so as to avoid the influence of stray diffracted light on the detection accuracy of the system. The Fraunhofer diffraction field distribution of an ideal wavefront lateral shearing grating can be expressed as

$${T}_{i d e a l} = δ ( u - \frac{1}{d} , v - \frac{1}{d} ) + δ ( u - \frac{1}{d} , v + \frac{1}{d} ) + δ ( u + \frac{1}{d} , v - \frac{1}{d} ) + δ ( u + \frac{1}{d} , v + \frac{1}{d} ) , \qquad ( 1 )$$

where μ=λ/x and v=λ/y are frequency domain coordinates corresponding to spatial coordinates x and y respectively, λ is the wavelength of the light source, and d is the spacing between adjacent grids of the grating, i.e. the grating period (see FIG. 7C). The function δ is a Dirac function, i.e. a general function or distribution defined on a real number line, which is equal to zero at all points except zero, and the integral of which in the entire domain of definition is equal to 1. According to the Fraunhofer diffraction theory, the field distribution on the observation surface is a Fourier transform result of the transmitted light field distribution of the diffraction grating. When an ideal planar wave is incident on the grating vertically, the transmitted light distribution function of the grating can be obtained through an inverse Fourier transform of the Equation (1), i.e.

$${t}_{i d e a l} ( x , y ) = {F}^{- 1} [ {T}_{i d e a l} ( u , v ) ] = cos ( \frac{2 π x}{d} ) \cdot cos ( \frac{2 π y}{d} ) . \qquad ( 2 )$$

As can be seen from the Equation (2), the value range of the light transmittance of the lateral shearing grating is [−1, 1], and an amplitude grating cannot achieve a negative refractive index. Therefore, the above equation is rewritten as the product of the absolute value of the light transmittance distribution function and a positive and negative sign function.

t_{ideal}(x,y)=sgn[t_{ideal}(x,y)]·abs[t_{ideal}(x,y)] (3)

The positive and negative sign function can be easily realized by means of a periodically alternating phase grating with phase delays 0 and π. The amount of phase delay can be expressed as the convolution of a rectangular function and a comb function in directions x and y, i.e.

$${φ}_{p h a s e} ( x , y ) = π \cdot [ rect ( \frac{2 x}{d} ) * comb ( \frac{x}{d} ) ] \cdot [ rect ( \frac{2 y}{d} ) * comb ( \frac{y}{d} ) ] . \qquad ( 4 )$$

As can be seen from the above equation, the corresponding light transmittance of the grating is −1 at the position where the phase delay is π, and is 1 at the position where the phase delay is 0. Therefore, the ideal light transmittance distribution of the shearing grating is

$${t}_{ideal} ( x , y ) = \vert cos ( \frac{2 π x}{d} ) \cdot cos ( \frac{2 π y}{d} ) \vert \cdot exp [ i {φ}_{phase} ( x , y ) ] . \qquad ( 5 )$$

FIGS. 7A-7C show schematic diagrams of a phase-difference micro-lens array 700 according to an embodiment of the present invention. In some embodiments of the present invention, as an alternative to an ideal grating with continuous transmittance change, the phase-difference micro-lens array 700 performs phase modulation on the incident light wave by means of the height difference between the spatial positions of adjacent micro-lenses; in particular, it performs π phase modulation on the incident light wave by means of the height difference between adjacent micro-lenses in the axial direction z. FIG. 7A shows front convex micro-lenses 710 and rear convex micro-lenses 720 arranged in a staggered manner on adjacent grids. The phase-difference micro-lens array 700 in the present invention may be a m×m grid array (m is a positive integer greater than or equal to 2). FIG. 7B schematically shows a 7×7 grid array. FIG. 7C shows each grid 750 in the phase-difference micro-lens array 700 (e.g., shown by a dashed box in FIG. 7B). As can be seen from FIGS. 7A-7C, the spacing between the grids is d. The micro-lens is arranged at the center of the grid, and the projection of the micro-lens on a plane perpendicular to the axial direction z is approximately a circle with a radius r. The phase-difference micro-lens array 700 comprises a substrate 730 in thickness of H, and front convex micro-lenses 710 and rear convex micro-lenses 720 that form a height difference h in the axial direction z. Alternatively, the front convex micro-lenses 710 and the rear convex micro-lenses 720 in the present invention may be micro-lens arrays formed integrally with the substrate 730 from the same material. In a preferred embodiment of the present invention, the front convex micro-lenses 710 and the rear convex micro-lenses 720 protrude in a direction reversed to the z-axis. The front convex micro-lenses 710 and the rear convex micro-lenses 720 are distributed in a staggered manner on the grid array shown in FIG. 7B. That is to say, each convex micro-lens 710 is surrounded by convex micro-lenses 720 in the upward, downward, leftward and rightward directions (unless it reaches an edge of the grid array), and each convex micro-lens 720 is surrounded by convex micro-lenses 710 in the upward, downward, leftward and rightward directions (unless it reaches an edge of the grid array). The phase-difference micro-lens array 700 utilizes material refraction to realize continuous change of the incident wave transmittance, and utilizes the height difference between the top part 712 of the front convex micro-lenses 710 and the top part 722 of the rear convex micro-lenses 720 in the axial direction z to realize π phase modulation at the same time. The present invention does not exclude using other components such as a diaphragm, a grating or a micro-lens array to realize π phase modulation; for example, the phase modulation can be realized by using different materials, incident angles or size changes of adjacent grids.

As shown in FIG. 7A, in the subsequent wavefront reconstruction operations, the light transmittance of the top part 712 of the convex micro-lenses 710 is calculated as 1. The light transmittance of the top part 732 of the substrate 730 is calculated as 0. The light transmittance of the top part 722 of the rear convex micro-lenses 720 is calculated as −1. The height difference between the top part 712 of the convex micro-lenses 710 and the top part 722 of the convex micro-lenses 720 in the axial direction z is

$$h = \frac{λ}{2 ( n - 1 )} \qquad ( 6 )$$

where n is the refractive index of the material of the phase-difference micro-lens array, and λ is the incident wavelength. In order to eliminate the influence of even-order light and ±3-order diffracted light on the measurement, the duty ratio of each micro-lens in the phase-difference micro-lens array 700 is 2:3. As shown in FIG. 7C, the duty ratio can be expressed as

$$\frac{π {r}^{2}}{{d}^{2}} = \frac{2}{3} \qquad ( 7 )$$

where r is the radius of the aperture of each micro-lens, and d is the spacing between the grids. Please see FIGS. 7D-7E. FIG. 7D shows the aperture D of the incident light and the shearing amount S, and FIG. 7E shows the distance L between the CCD camera and the phase-difference micro-lens array. It is noted that the following parameters are important parameters that affect the shearing rate of the system: the thickness H of the substrate 730 of the phase-difference micro-lens array, the aperture D of the incident light, and the distance L between the CCD camera 360 and the phase-difference micro-lens array 700. As can be seen from the geometric relationship shown in FIGS. 7D and 7E, the shearing amount S is

$$S = 2 L tan [ arcsin ( \frac{n λ}{d} ) ] + 2 H tan [ arcsin ( \frac{λ}{d} ) ] . \qquad ( 8 )$$

Then the shearing ratio β is

$$β = \frac{S}{D} . \qquad ( 9 )$$

The smaller the shearing ratio is, the smaller the staggered distance of the wavefronts will be, the more portions of the wavefronts will participate in the interference, the greater the measurable aperture will be, and the higher the accuracy of wavefront reconstruction will be; the greater the shearing ratio is, the greater the staggered distance of the wavefronts will be, the less portions of the wavefront will participate in the interference, and the higher the measurement sensitivity will be, but the smaller the measurable aperture will be and the lower the accuracy of reconstruction of the corresponding wavefronts will be. Therefore, in actual applications, the shearing ratio of multi-beam lateral shearing interference technique should have a high degree of freedom of adjustment. The function of adjusting the shearing ratio by adjusting the spatial light modulator 340 will be described in detail below.

A spatial light modulator is suitable for adjusting key shearing parameters, and may be a traditional optical device or a liquid crystal array, for example. The light transmittance of liquid crystal can be change by adjusting the voltage. In the present invention, an adaptive technique based on machine learning is introduced into the spatial light modulator for realizing automatic modulation of the wavefront measurement. FIG. 8 shows a schematic diagram of the wavefront modulation based on machine learning according to some embodiments of the present invention. In some embodiments of the present invention, the adaptive spatial light modulator 340 based on machine learning can automatically adjust key shearing parameters, such as the duty ratio, shearing amount, and illumination intensity, etc., such that only the signal order 0 and orders ±1 in the diffraction spectrum are left.

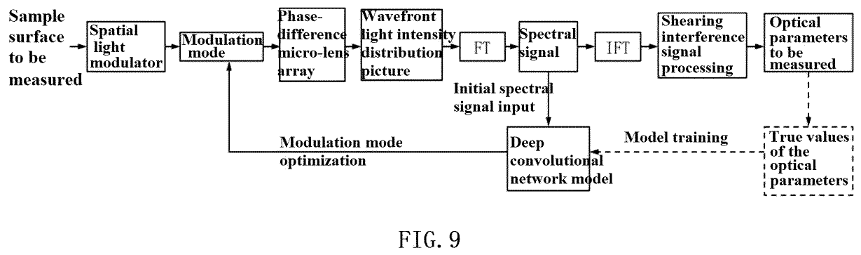

FIG. 9 shows a method for self-optimization of the shearing interference modulation mode based on machine learning according to some embodiments of the present invention. The machine learning model will be able to output an adaptive modulation mode for the sample to be measured according to the spectral signal in an initial modulation mode.

First, in an initial modulation mode, light intensity distribution of the initial wavefront can be obtained, and a spectral signal corresponding to the initial wavefront can be obtained through a Fourier transform (FT). The obtained initial spectral signal is inputted to the machine learning model for inference, and a modulation mode suitable for the sample to be measured is obtained; the modulation mode of the spatial light modulator is optimized, so that an optimized spectral signal is obtained; and finally, the optical parameters of the sample to be measured are obtained through an inverse Fourier transform (IFT) and shearing interference signal processing.

In the intelligent adaptive process, the machine learning model is established by using a deep convolution neural network, which can process the inputted two-dimensional spectral signal, perform feature extraction and reconstruction on the inputted signal through the deep convolution layers, and finally output an optimized modulation mode.

Preferably, a training process of the machine learning model can be carried out in a simulation environment; the optical parameters of the designed structure are obtained in the simulation by designing a sample to be measured with a complex structure; in view that the optical parameters are known, the optical parameters may be used as true values for training the deep convolutional neural network, and finally a trained machine learning model is obtained through continuous iterative learning and training. The deep convolutional network model can output an adaptive modulation mode for the sample to be measured according to the spectral signal in an initial modulation mode.

In order to simulate the diffraction effect of the shearing generator 300, planar wave incidence is used to generate Fraunhofer diffraction, and the distribution of the diffraction field is as follows:

$$U ( x , y ) = \frac{1}{j λ L} exp ( jKL ) exp [ \frac{jK}{2 L} ( {x}^{2} + {y}^{2} ) ] F [ t ( x , y ) ] \qquad ( 10 )$$

where t(x, y) is the transmittance distribution of the grating, F[⋅] represents a Fourier transform, a wave number

$$K = \frac{2 π}{λ}$$

represents the phase change generated per unit length, λ is the wavelength of the light source, and L is the distance between the CCD camera and the phase-difference micro-lens array.

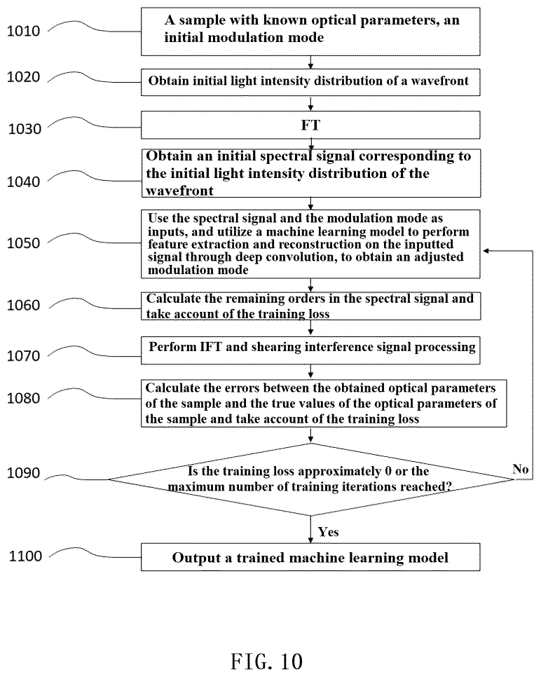

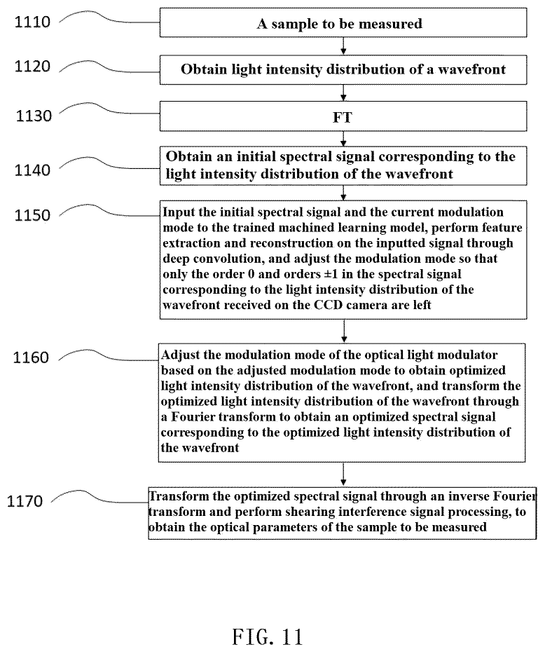

FIG. 10 shows a flowchart of a training method for the intelligent adaptive wavefront measurement method for optical characterization in a simulation environment according to some embodiments of the present invention. First, in step 1010, in the system shown in FIG. 3, the light emitted from a light source 310 passes through a sample 320 with known optical parameters, and passes through a shearing generator 330. In step 1020, an initial wavefront light intensity distribution picture is obtained at the CCD camera 360. The shearing generator 330 includes a spatial light modulator 340 operating in an initial modulation mode, and may further include a phase-difference micro-lens array 350 or any other optical device capable of generating a phase difference of π. In step 1030, the initial wavefront light intensity distribution is transformed through a Fourier transform by any computing device in the prior art. In step 1040, an initial spectral signal corresponding to the initial wavefront light intensity distribution is obtained. In step 1050, the spectral signal and the modulation mode are taken as inputs, and a machine learning model is used to perform feature extraction and reconstruction on the inputted signal through deep convolution to obtain an adjusted modulation mode. In step 1060, the remaining orders in the spectral signal are calculated and the training loss is taken into account. In step 1070, the spectral signal is subjected to inverse Fourier transform and shearing interference signal processing. In step 1080, errors between the obtained optical parameters of the sample and the known true values of the optical parameters of the sample are calculated, and the training loss is taken into account. In step 1090, whether the training loss is close to zero or the maximum number of training iterations has reached is judged, and, if the result of the judgment is positive, the process proceeds to step 1100, otherwise the process returns to step 1050. In step 1100, a trained machine learning model is outputted.

FIG. 11 shows a flowchart of the intelligent adaptive wavefront measurement method for optical characterization according to some embodiments of the present invention. First, in step 1110, in the system shown in FIG. 3, the light emitted from a light source 310 passes through a sample 320 to be measured, and passes through a shearing generator 330. In step 1120, an initial wavefront light intensity distribution picture is obtained at the CCD camera 360. The shearing generator 330 includes a spatial light modulator 340 operating in an initial mode, and may further include a phase-difference micro-lens array 350 or any other optical device capable of generating a phase difference of π. In step 1130, the initial wavefront light intensity distribution is transformed through a Fourier transform by any computing device in the prior art. In step 1140, an initial spectral signal corresponding to the initial wavefront light intensity distribution is obtained. In step 1150, the initial spectral signal and the current modulation mode are inputted into a trained machine learning model, feature extraction and reconstruction are performed on the inputted signal through deep convolution, and the modulation mode is adjusted, so that only the signal order 0 and orders ±1 in the spectral signal corresponding to the light intensity distribution of the wavefront received on the photoelectric coupler are left. In step 1160, the modulation mode of the spatial light modulator is adjusted based on the adjusted modulation mode to obtain optimized light intensity distribution of the wavefront, and the optimized light intensity distribution of the wavefront is transformed through a Fourier transform to obtain an optimized spectral signal corresponding to the optimized light intensity distribution of the wavefront. In step 1170, the optimized spectral signal is transformed through an inverse Fourier transform and shearing interference signal processing is performed, to obtain the optical parameters of the sample to be measured.

Please note that the process flow and the sequence of the steps in FIGS. 10 and 11 are illustrative rather than limitative. Those skilled in the art can make adjustments or modifications to the steps and sequence on a practical basis.

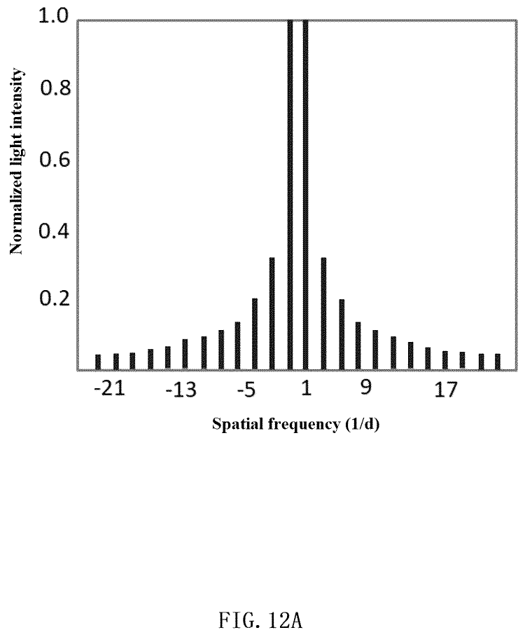

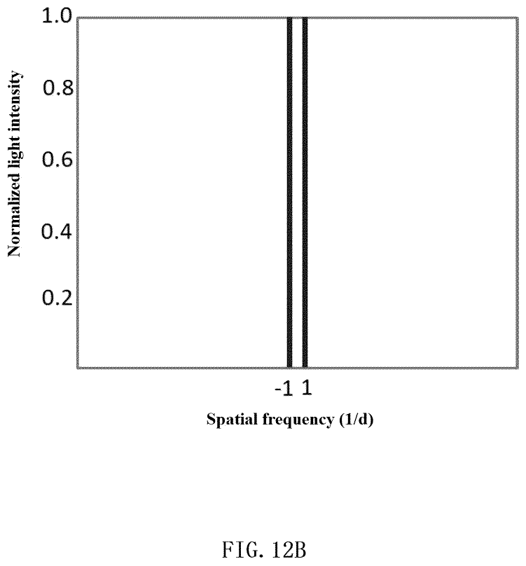

FIG. 12A shows an unmodulated spectrogram according to some embodiments of the present invention. In FIG. 12A, the horizontal coordinate represents the spatial frequency, in unit of 1/d, where d is the spacing between the grids; and the vertical coordinate represents the normalized light intensity of the diffraction field.

FIG. 12B shows a modulated spectrogram according to some embodiments of the present invention. In FIG. 12B, the horizontal coordinate represents the spatial frequency, in unit of 1/d, where d is the spacing between the grids; and the vertical coordinate represents the normalized light intensity of the diffraction field. It can be seen that only 0-order (not shown) light and ±1-order light are left in the modulated spectrum, while most of the higher-order light is eliminated. Compared with the improved Hartmann mask (MHM) and phase grating commonly used at present, the diffraction effect is closer to that of an ideal grating.

The present invention can be widely used in optical parameter measurement, such as light beam quality evaluation, optical element detection, meta-surfaces, refractive indexes of materials, laser atmospheric communication, and human eye aberration measurement, etc.

Compared with the prior art, the present invention provides a novel intelligent adaptive measurement system, in view that there is no integrated characterization means for multiple optical parameters at present. The system can be widely applied in various wavefront measurement scenarios, such as laser beam quality, diopter distribution of spectacle lenses, metamaterials, precision lens assembling, refractive index distribution of materials and the like.

For the problem of differentiated measurement scenarios, the adaptive technique based on machine learning proposed by the present invention will be applied to the wavefront modulation of spatial light modulators. The method in the present invention can accurately and automatically modulate the incident wavefront into any wavefront, and the technique provides a basis for the integration of measurement systems.

For the problem of the influence of high-order diffracted light in shearing interference, the spatial light modulator and the phase-difference micro-lens array proposed by the present invention are combined into a shearing generator, which can realize near single-order diffraction and greatly improve the sensitivity and resolution of the system.

While the present invention is illustrated and described above in detail in some embodiments with reference to the accompanying drawings, the above embodiments are only illustrative rather than limitative. The present invention further covers various combinations, modifications and variations of the exemplary embodiments made without departing from the spirit and scope of the present invention.

What is claimed is:

1. An intelligent adaptive wavefront measurement system for optical characterization, the system being capable of obtaining optical parameters of a sample to be measured, the system comprising a light source, a shearing generator and a photoelectric coupler that are arranged sequentially in an axial direction, wherein the shearing generator comprises a spatial light modulator and a phase-difference micro-lens array that are arranged sequentially in the axial direction.

2. The system according to claim 1, wherein the phase-difference micro-lens array comprises front convex micro-lenses and rear convex micro-lenses that are arranged in a staggered manner on adjacent grids, and the phase-difference micro-lens array performs π phase modulation on incident light waves by means of a height difference between top part of the front convex micro-lenses and top part of the rear convex micro-lenses in the axial direction.

3. The system according to claim 1, wherein in subsequent wavefront reconstruction operations, a light transmittance of a top part of the front convex micro-lenses is calculated as 1, a light transmittance of a top part of the substrate of the phase-difference micro-lens array is calculated as 0, and a light transmittance of a top part of the rear convex micro-lenses is calculated as −1, wherein the height difference is
$$h = \frac{λ}{2 ( n - 1 )} ,$$
where n is a retractive index of a material of the phase-difference micro-lens array, and/is an incident wavelength.

4. The system according to claim 1, wherein a duty ratio of each micro-lens in the phase-difference micro-lens array in the grid of the micro-lens is
$$\frac{π {r}^{2}}{{d}^{2}} ,$$
where r is a radius of an aperture of each micro-lens and d is a spacing between the grids.

5. The system according to claim 4, wherein the duty ratio is 2:3.

6. The system according to claim 1, wherein a shearing ratio of the shearing generator is
$$β = \frac{S}{D} ,$$
where S is a shearing amount, and D is an aperture of incident light, wherein
$$S = 2 L tan [ arcsin ( \frac{n λ}{d} ) ] + 2 H tan [ arcsin ( \frac{λ}{d} ) ]$$
where L is a distance between the photoelectric coupler and the phase-difference micro-lens array, H is a thickness of the substrate of the phase-difference micro-lens array, λ is an incident wavelength, and d is a spacing between the grids.

7. The system according to claim 1, wherein the spatial light modulator modulates shearing parameters, the shearing parameters including at least one of a duty ratio, a shearing amount and an illumination intensity of each micro-lens in the phase-difference micro-lens array in the grid of the micro-lens.

8. The system according to claim 1, wherein the spatial light modulator optimizes its modulation mode based on a machine learning model, so that the machine learning model can output an adaptive modulation mode for the sample to be measured according to a spectral signal in an initial modulation mode.

9. The system according to claim 8, wherein the machine learning model is established by using a deep convolution neural network.

10. The system according to claim 8, wherein the machine learning model is capable of optimizing the modulation mode of the spatial light modulator such that only the signal order 0 and orders ±1 in the spectral signal corresponding to a light intensity distribution of a wavefront received on the photoelectric coupler are left.

11. The system according to claim 9, wherein: a training process of the machine learning model can be carried out in a simulation environment; the optical parameters of the designed structure are obtained in the simulation by designing the sample to be measured with a complex structure; since the optical parameters are known, the optical parameters are used as true values for training the deep convolutional neural network, and finally a trained machine learning model is obtained through continuous iterative learning and training.

12. An intelligent adaptive wavefront measurement method for optical characterization, comprising the following steps:
a) introducing an incident light wave from a light source to pass through a sample to be measured, a shearing generator and a photoelectric coupler that are arranged sequentially in an axial direction, to obtain a light intensity distribution of a wavefront, wherein the shearing generator comprises a spatial light modulator and a phase-difference micro-lens array that are arranged sequentially in the axial direction; b) transforming the light intensity distribution of the wavefront through a Fourier transform to obtain a spectral signal corresponding to the light intensity distribution of the wavefront; and
c) transforming the spectral signal through an inverse Fourier transform and performing shearing interference signal processing, to obtain the optical parameters of the sample to be measured.

13. The method according to claim 12, wherein the phase-difference micro-lens array comprises front convex micro-lenses and rear convex micro-lenses that are arranged in a staggered manner on adjacent grids, and the phase-difference micro-lens array performs π phase modulation on incident light waves by means of a height difference between a top part of the front convex micro-lenses and a top part of the rear convex micro-lenses in the axial direction.

14. The method according to claim 12, wherein a light transmittance of the front convex micro-lenses is 1, a light transmittance of the bottom part is 0, and a light transmittance of the rear convex micro-lenses is −1, wherein the height difference
$$h = \frac{λ}{2 ( n - 1 )} ,$$
where n is a refractive index of a material of the phase-difference micro-lens array, and λ is an incident wavelength.

15. The method according to claim 12, wherein a duty ratio of each micro-lens in the phase-difference micro-lens array in the grid of the micro-lens is
$$\frac{π {r}^{2}}{{d}^{2}} ,$$
where r is a radius of an aperture of each micro-lens and d is a spacing between the grids.

16. The method according to claim 15, wherein the duty ratio is 2:3.

17. The method according to claim 12, wherein a shearing ratio of the shearing generator is
$$β = \frac{S}{D} ,$$
where S is a shearing amount, and D is an aperture of incident light, wherein
$$S = 2 L tan [ arcsin ( \frac{n λ}{d} ) ] + 2 H tan [ arcsin ( \frac{λ}{d} ) ] ,$$
where L is a distance between the photoelectric coupler and the phase-difference micro-lens array, H is a thickness of the substrate of the phase-difference micro-lens array, λ is an incident wavelength, and d is a spacing between the grids.

18. The method according to claim 12, wherein the spatial light modulator modulates shearing parameters, the shearing parameters including at least one of a duty ratio, a shearing amount and an illumination intensity of each micro-lens in the phase-difference micro-lens array in the grid of the micro-lens.

19. The method according to claim 12, wherein the spatial light modulator optimizes its modulation mode based on a machine learning model, so that the machine learning model can output an adaptive modulation mode for the sample to be measured according to a spectral signal in an initial modulation mode.

20. The method according to claim 19, wherein the machine learning model is established by using a deep convolution neural network.

21. The method according to claim 19, wherein the machine learning model is capable of optimizing the modulation mode of the spatial light modulator such that only the signal order 0 and orders ±1 in the spectral signal corresponding to a light intensity distribution of a wavefront received on the photoelectric coupler are left.

22. The method according to claim 20, wherein a training process of the machine learning model can be carried out in a simulation environment; the optical parameters of the designed structure are obtained in the simulation by designing the sample to be measured with a complex structure; since the optical parameters are known, the optical parameters are used as true values for training the deep convolutional neural network, and finally a trained machine learning model is obtained through continuous iterative learning and training.

23. A training method for an intelligent adaptive wavefront measurement method for optical characterization in a simulation environment, comprising the following steps:
a) in a simulation environment, introducing an incident light wave from a light source to pass through a sample with known optical parameters, a spatial light modulator, a phase-difference micro-lens array and a photoelectric coupler that are arranged sequentially in an axial direction, to obtain an initial light intensity distribution of a wavefront, wherein the spatial light modulator works in an initial modulation mode;
b) transforming the initial light intensity distribution of the wavefront through a Fourier transform to obtain an initial spectral signal corresponding to the initial light intensity distribution of the wavefront;
c) inputting the initial spectral signal and the current modulation mode into a machine learning model established by using a deep convolution neural network, performing feature extraction and reconstruction on the inputted signal through deep convolution, and outputting an adjusted modulation mode;
d) calculating the remaining orders in the spectral signal at this point, and taking account of a training loss for model training;
e) obtaining an adjusted light intensity distribution of the wavefront based on the adjusted modulation mode, and transforming the adjusted light intensity distribution of the wavefront through a Fourier transform to obtain an adjusted spectral signal corresponding to the adjusted light intensity distribution of the wavefront;
f) transforming the adjusted spectral signal through an inverse Fourier transform and performing shearing interference signal processing to obtain the optical parameters of the sample, and calculating errors between the obtained optical parameters and true values of the known optical parameters, and taking account of the errors into the training loss; and
g) iteratively training the model according to the obtained training loss, and finally obtaining a trained machine learning model.

24. An intelligent adaptive wavefront measurement method for optical characterization, comprising the following steps:
a) introducing an incident light wave from a light source to pass through a sample to be measured, a spatial light modulator, a phase-difference micro-lens array and a photoelectric coupler that are arranged sequentially in an axial direction, to obtain an initial light intensity distribution of a wavefront, wherein the spatial light modulator works in an initial modulation mode;
b) transforming the initial light intensity distribution of the wavefront through a Fourier transform to obtain an initial spectral signal corresponding to the initial light intensity distribution of the wavefront;
c) inputting the initial spectral signal and the current modulation mode into a trained machine learning model, performing feature extraction and reconstruction on the inputted signal through deep convolution, and adjusting the modulation mode, so that only the signal order 0 and orders ±1 in the spectral signal corresponding to the light intensity distribution of the wavefront received on the photoelectric coupler are left;
d) adjusting the modulation mode of the spatial light modulator based on the adjusted modulation mode to obtain optimized light intensity distribution of the wavefront, and transforming the optimized light intensity distribution of the wavefront through a Fourier transform to obtain an optimized spectral signal corresponding to the optimized light intensity distribution of the wavefront; and
e) transforming the optimized spectral signal through an inverse Fourier transform and performing shearing interference signal processing to obtain the optical parameters of the sample to be measured.
